(19) United States
(12) Patent Application Publication
(10) Pub. No.: US 2013/0088507 A1
(43) Pub. Date: Apr. 11, 2013

(54) METHOD AND APPARATUS FOR CONTROLLING THE VISUAL REPRESENTATION OF INFORMATION UPON A SEE-THROUGH DISPLAY

(71) Applicant: Sean White, Los Angeles, CA (US)

(72) Inventor: Sean White, Los Angeles, CA (US)

(73) Assignee: NOKIA CORPORATION, Espoo (FI)

(21) Appl. No.: 13/267,531

(22) Filed: Oct. 6, 2011

(51) Int. Cl. G09G 5/02; G09G 5/00

(52) U.S. Cl. 345/592; 345/7; 345/660; 345/672

(57) ABSTRACT

A method, apparatus and computer program product are provided for controlling the presentation of a visual representation of information upon a see-through display. In the context of a method, a visual representation of information is initially caused to be presented on a see-through display. At least a portion of the information at least partially occludes a user's view through the see-through display. The method also determines a context associated with the user. For example, the method may determine the context associated with the user by receiving data based upon an activity of the user and determining the activity performed by the user based upon the data. Regardless of the manner in which the context is determined, the method reduces occlusion of the user's view through the see-through display attributable to the visual representation of the information based at least in part on the context associated with the user.

### TECHNOLOGICAL FIELD

An example embodiment of the present invention relates generally to see-through displays and, more particularly to a method, apparatus and computer program product for controlling the visual representation of information upon a see-through display.

### BACKGROUND

One type of user interface is a see-through display. A see-through display provides a display upon which a visual representation of information may be presented. However, a see-through display is also designed such that a user may not only view the visual representation of the information presented upon the display, but may also optically see through the display in order to view a scene beyond the display, such as view the user's surroundings. By presenting a visual representation of information upon the display that a user can view while also permitting the user to view the scene beyond the see-through display, see-through displays may be useful in augmented reality as well as other applications.

See-through displays may be embodied in various manners including as near-eye displays, such as head worn displays. For example, a near-eye display may be embodied in a pair of glasses that are worn by a user and through which the user can view a scene beyond the glasses. In instances in which the glasses are configured to function as a see-through display, however, a visual representation of information may also be presented upon the glasses and, more particularly, upon one or both lenses of the glasses that can also be viewed by user concurrent with the user's view through the lenses of the scene beyond the glasses. Other examples of a see-through display may include a windshield, a visor or other display surface upon which a visual representation may be presented and through which a user may optically view the user's surroundings.

While the visual representation of information upon the see-through display may be helpful for informational, entertainment or other purposes, the visual representation of the information may at least partially occlude the user's view of the scene beyond the see-through display. In instances in which the see-through display is embodied in a pair of glasses or other head-mounted display, the user may be tempted to remove the see-through display in order to view their surroundings without the occlusive effect that may otherwise be created by the visual representation of the information upon the display. However, the removal of the see-through display in these instances may disadvantageously effect the user experience. In this regard, the see-through display may be designed in such a fashion as to be worn continuously by a user regardless of whether a visual representation of information is presented upon the display. For example, the see-through display may provide functional advantages to the user in addition to the presentation of a visual representation of information upon the display. Indeed, in an instance in which the see-through display is embodied as a pair of glasses, the lenses may be tinted or otherwise designed to reduce glare and/or the lenses may be prescription lenses that serve to correct the user's eyesight. By removing the see-through display to eliminate the occlusive effect created by the visual representation of the information upon the display, the user not only has to go to the effort to repeatedly don and remove the see-through display, but the user will no longer enjoy the other functional advantages provided by the see-through display once the see-through display has been removed.

### BRIEF SUMMARY

A method, apparatus and computer program product are therefore provided for controlling the presentation of the visual representation of information upon a see-through display. In one example embodiment, the method, apparatus and computer program product may control the visual representation of information upon the see-through display based upon a context associated with the user, such as an activity being performed by the user. As such, the occlusion of the user's view of the scene beyond the see-through display may be controlled based, at least in part, upon the context associated with the user. By controlling the visual representation of information upon the see-through display and, in turn, the occlusion of the user's view of the scene beyond the see-through display based at least in part upon the context associated with the user, such as the activity currently being performed by the user, the occlusion created by the visual representation of information upon the see-through display may be reduced in some situations, such as situations in which should pay increased attention to their surroundings, such that the user may more clearly or fully view the scene beyond the see-through display.

Accordingly, the method, apparatus and computer program product of an example embodiment may improve the user experience offered by a see-through display by presenting a visual representation of information upon the see-through display in a manner that is controlled in accordance with the context associated with the user so as to reduce the instances in which the occlusion created by the visual representation of the information upon the see-through display will undesirably limit the user's view of a scene beyond the see-through display. However, in other situations in which the context associated with the user indicates that the user may devote more attention to the additional information presented upon the see-through display, the method, apparatus and computer program product of an example embodiment may provide a more fulsome view of the additional information that is presented upon the see-through display.

In one embodiment, a method is provided that includes causing presentation of a visual representation of information on a see-through display. At least a portion of the information at least partially occludes a user's view through the see-through display. The method also determines a context associated with the user. In one embodiment, the method may determine the context associated with the user by receiving data based upon an activity of the user and determining the activity performed by the user based upon the data. Regardless of the manner in which the context is determined, the method reduces occlusion of the user's view through the see-through display attributable to the visual representation of the information based at least in part on the context associated with the user.

The occlusion to the user's view may be reduced in various manners. For example, the method may reduce the occlusion of the user's view by reducing a size and/or an opacity of the visual representation of the information presented upon the see-through display. Additionally or alternatively, the method may reduce the occlusion of the user's view by causing the visual representation of the information to be moved from an occluding portion of the see-through display in which the visual representation of the information at least partially occludes the user's view of an object through the see-through display to a less-occluding portion of the see-through display in which the visual representation of the information creates less occlusion of the user's view of the object through the see-through display. The method may also or alternatively reduce the occlusion of the user's view by changing an optical characteristic and/or the informational content or complexity of the visual representation of the information presented upon the see-through display. Additionally or alternatively, the method may reduce the occlusion of the user's view by causing the visual representation of the information to be modified differently in a central portion of the see-through display than in a non-central portion of the see-through display.

In another embodiment, an apparatus is provided that includes at least one processor and at least one memory storing computer program code with the at least one memory and stored computer program code being configured, with the at least one processor, to cause the apparatus to at least cause presentation of a visual representation of information on a see-through display. At least a portion of the information at least partially occludes a user's view through the see-through display. The at least one memory and stored computer program code are also configured, with the at least one processor, to cause the apparatus to determine a context associated with the user. In one embodiment, the at least one memory and stored computer program code may be configured, with the at least one processor, to cause the apparatus to determine the context associated with the user by receiving data based upon an activity of the user and determining the activity performed by the user based upon the data. Regardless of the manner in which the context is determined, the at least one memory and stored computer program code are also configured, with the at least one processor, to cause the apparatus to reduce occlusion of the user's view through the see-through display attributable to the visual representation of the information based at least in part on the context associated with the user.

The occlusion to the user's view may be reduced in various manners. For example, the at least one memory and stored computer program code may be configured, with the at least one processor, to cause the apparatus to reduce the occlusion of the user's view by reducing a size and/or an opacity of the visual representation of the information presented upon the see-through display. Additionally or alternatively, the at least one memory and stored computer program code may be configured, with the at least one processor, to cause the apparatus to reduce the occlusion of the user's view by causing the visual representation of the information to be moved from an occluding portion of the see-through display in which the visual representation of the information at least partially occludes the user's view of an object through the see-through display to a less-occluding portion of the see-through display in which the visual representation of the information creates less occlusion of the user's view of the object through the see-through display. The at least one memory and stored computer program code may be configured, with the at least one processor, to cause the apparatus to also or alternatively reduce the occlusion of the user's view by changing an optical characteristic and/or the informational content or complexity of the visual representation of the information presented upon the see-through display. Additionally or alternatively, the at least one memory and stored computer program code may be configured, with the at least one processor, to cause the apparatus to reduce the occlusion of the user's view by causing the visual representation of the information to be modified differently in a central portion of the see-through display than in a non-central portion of the see-through display.

In a further embodiment, a computer program product is provided that includes at least one non-transitory computer-readable storage medium having computer-readable program instructions stored therein with the computer-readable program instructions including program instructions configured to cause presentation of a visual representation of information on a see-through display. At least a portion of the information at least partially occludes a user's view through the see-through display. The computer-readable program instructions also include program instructions configured to determine a context associated with the user. In one embodiment, the computer-readable program instructions may include program instructions configured to determine the context associated with the user by receiving data based upon an activity of the user and to determine the activity performed by the user based upon the data. Regardless of the manner in which the context is determined, the computer-readable program instructions include program instructions configured to reduce occlusion of the user's view through the see-through display attributable to the visual representation of the information based at least in part on the context associated with the user.

The computer-readable program instructions may also include program instructions configured to reduce the occlusion of the user's view by reducing a size and/or an opacity of the visual representation of the information presented upon the see-through display. Additionally or alternatively, the method may reduce the occlusion of the user's view by causing the visual representation of the information to be moved from an occluding portion of the see-through display in which the visual representation of the information at least partially occludes the user's view of an object through the see-through display to a less-occluding portion of the see-through display in which the visual representation of the information creates less occlusion of the user's view of the object through the see-through display.

In yet another embodiment, an apparatus is provided that includes means for causing presentation of a visual representation of information on a see-through display. At least a portion of the visual representation of the information at least partially occludes a user's view through the see-through display. The apparatus also includes means for determining a context associated with the user. In one embodiment, the apparatus may include means for determining the context associated with the user by receiving data based upon an activity of the user and means for determining the activity performed by the user based upon the data. Regardless of the manner in which the context is determined, the apparatus includes means for reducing occlusion of the user's view through the see-through display attributable to the visual representation of the information based at least in part on the context associated with the user.

### BRIEF DESCRIPTION OF THE DRAWINGS

Having thus described certain example embodiments of the present invention in general terms, reference will hereinafter be made to the accompanying drawings, which are not necessarily drawn to scale, and wherein:

FIG. 1 is a perspective view of a see-through display embodied by a pair of glasses in accordance with one example embodiment of the present invention;

FIG. 2 is a block diagram of an apparatus that may be specifically configured in accordance with an example embodiment of the present invention;

FIG. 3 is a block diagram of the operations performed in accordance with an example embodiment of the present invention;

FIG. 4 is a block diagram of the operations performed in accordance with another example embodiment to the present invention;

FIG. 5 is a representation of a see-through display in which the size of the visual representation of information presented upon the see-through display has been reduced in accordance with an example embodiment of the present invention;

FIG. 6 is a representation of a see-through display in which the opacity of the visual representation of information presented upon the see-through display has been reduced in accordance with an example embodiment of the present invention;

FIG. 7 is a representation of a see-through display in which the visual representation of the information has been moved from a central portion of the see-through display to a non-central portion of the see-through display in accordance with an example embodiment of the present invention; and

FIGS. 8A and 8B are representations of a see-through display in which the informational content of the visual representation of the information presented upon the see-through display has been changed in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

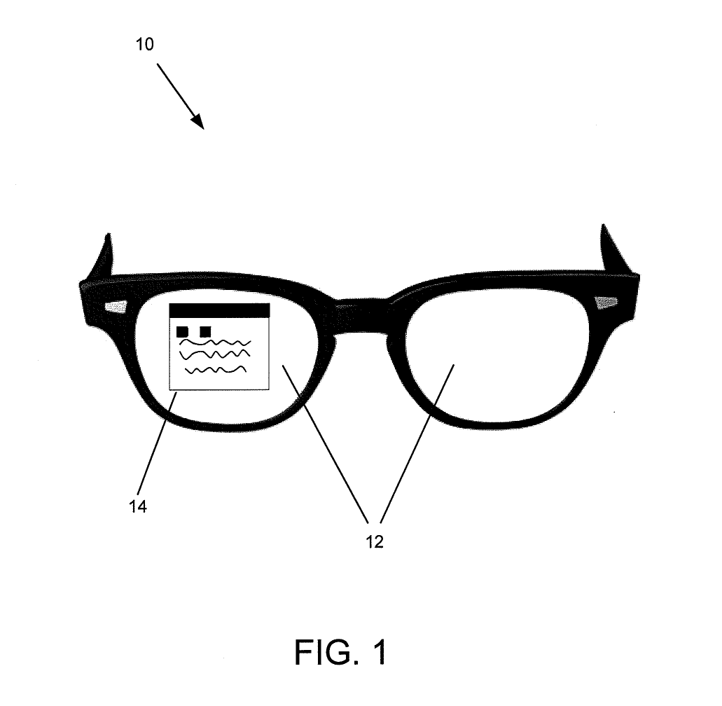

The methods, apparatus and computer program products of at least some example embodiments may control the presentation of a visual representation of information upon a see-through display based, at least in part, upon a context associated with a user of the see-through display so as to controllably reduce an occlusion of the user's view though the see-through display that may otherwise be created by the visual representation of the information. A see-through display may be embodied in various manners. For example, the see-through display may be a near-eye display, such as a head worn display, through which the user may optically view a scene external to the near-eye display. By way of example, a near-eye display of one embodiment is shown in FIG. 1 in the form of a pair of eyeglasses 10. The eyeglasses 10 may be worn by user such that the user may view a scene, e.g., a field of view, through the lenses 12 of the eyeglasses. However, the eyeglasses 10 of this embodiment may also be configured to present a visual representation of information 14 upon the lenses 12 so as to augment or supplement the user's view of the scene through the lenses of the eyeglasses. As such, the eyeglasses 10 may support augmented reality and other applications. As another example, the see-through display may be embodied by a windshield, a visor or other type of display though which a user optically views an image or a scene external to the display. While examples of a see-through display have been provided, a see-through display may be embodied in a number of different manners with a variety of form factors, each of which may permit a user to optically see through the display so as to view the user's surroundings and each of which of which may benefit from the method, apparatus and computer program product of an example embodiment of the present invention as described below.

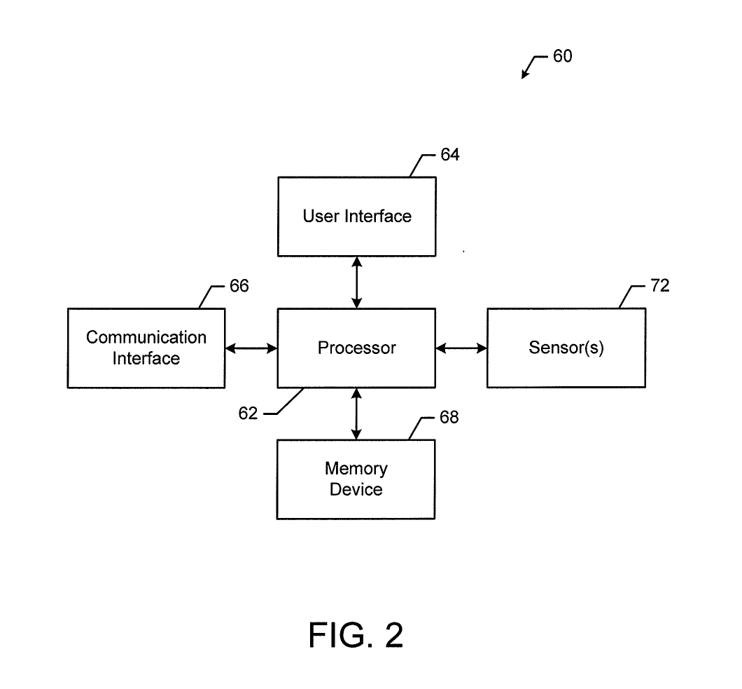

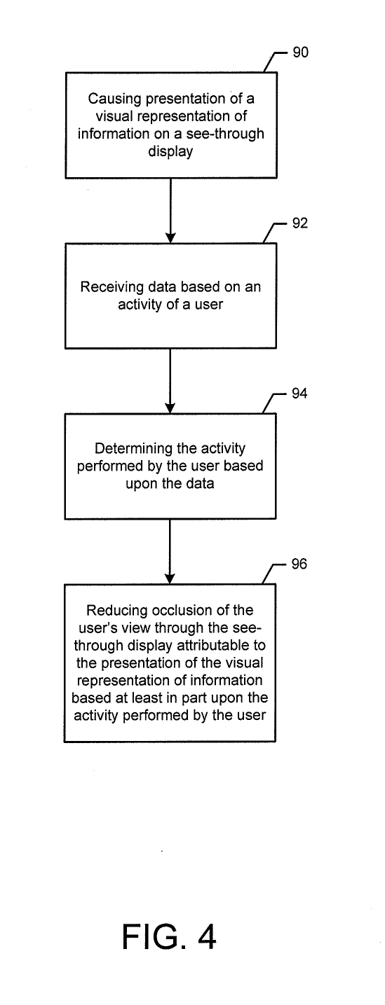

An example embodiment of the invention will now be described with reference to FIG. 2, in which certain elements of an apparatus 60 for controlling the visual representation of information upon a see-through display based, at least in part, upon a context associated with a user are depicted. The apparatus 60 of FIG. 4 may be employed, for example, in conjunction with, such as by being incorporated into or embodied by, the eyeglasses 10 of FIG. 1. However, it should be noted that the apparatus 60 of FIG. 2 may also be employed in connection with a variety of other devices and therefore, embodiments of the present invention should not be limited to application on the eyeglasses of FIG. 1.

It should also be noted that while FIG. 2 illustrates one example of a configuration of an apparatus 60 for controlling the presentation of information upon a see-through display based, at least in part, upon a context associated with a user, numerous other configurations may also be used to implement embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring now to FIG. 2, the apparatus 60 for controlling the presentation of a visual representation of information upon a see-through display based, at least in part, upon a context associated with a user may include or otherwise be in communication with a processor 62, a user interface 64, such as a display, a communication interface 66, and a memory device 68. In some embodiments, the processor 62 (and/or co-processors or any other processing circuitry assisting or otherwise associated with the processor) may be in communication with the memory device 68 via a bus for passing information among components of the apparatus 60. The memory device 68 may include, for example, one or more volatile and/or non-volatile memories. In other words, for example, the memory device 68 may be an electronic storage device (e.g., a computer readable storage medium) comprising gates configured to store data (e.g., bits) that may be retrievable by a machine (e.g., a computing device like the processor 62). In the embodiment in which the apparatus 60 is embodied as a mobile terminal 30, the memory device 68 may be embodied by the memory 52, 54. The memory device 68 may be configured to store information, data, content, applications, instructions, or the like for enabling the apparatus to carry out various functions in accordance with an example embodiment of the present invention. For example, the memory device 68 could be configured to buffer input data for processing by the processor 62. Additionally or alternatively, the memory device 68 could be configured to store instructions for execution by the processor 62.

The apparatus 60 may be embodied by a pair of eyeglasses 10 or other head-mounted display, a windshield, a visor or other augmented reality device configured to employ an example embodiment of the present invention. However, in some embodiments, the apparatus 60 may be embodied as a chip or chip set. In other words, the apparatus 60 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 60 may therefore, in some cases, be configured to implement an embodiment of the present invention on a single chip or as a single “system on a chip.” As such, in some cases, a chip or chipset may constitute means for performing one or more operations for providing the functionalities described herein.

The processor 62 may be embodied in a number of different ways. For example, the processor 62 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 62 may include one or more processing cores configured to perform independently. A multi-core processor may enable multiprocessing within a single physical package. Additionally or alternatively, the processor 62 may include one or more processors configured in tandem via the bus to enable independent execution of instructions, pipelining and/or multithreading. In the embodiment in which the apparatus 60 is embodied as a mobile terminal 30, the processor 62 may be embodied by the processor 38.

In an example embodiment, the processor 62 may be configured to execute instructions stored in the memory device 68 or otherwise accessible to the processor. Alternatively or additionally, the processor 62 may be configured to execute hard coded functionality. As such, whether configured by hardware or software methods, or by a combination thereof, the processor 62 may represent an entity (e.g., physically embodied in circuitry) capable of performing operations according to an embodiment of the present invention while configured accordingly. Thus, for example, when the processor 62 is embodied as an ASIC, FPGA or the like, the processor may be specifically configured hardware for conducting the operations described herein. Alternatively, as another example, when the processor 62 is embodied as an executor of software instructions, the instructions may specifically configure the processor 62 to perform the algorithms and/or operations described herein when the instructions are executed. However, in some cases, the processor 62 may be a processor of a specific device (e.g., a mobile terminal 30 or other hand-held device 20) configured to employ an embodiment of the present invention by further configuration of the processor 62 by instructions for performing the algorithms and/or operations described herein. The processor 62 may include, among other things, a clock, an arithmetic logic unit (ALU) and logic gates configured to support operation of the processor.

Meanwhile, the communication interface 66 may be any means such as a device or circuitry embodied in either hardware or a combination of hardware and software that is configured to receive and/or transmit data from/to a network and/or any other device or module in communication with the apparatus 60. In this regard, the communication interface 66 may include, for example, an antenna (or multiple antennas) and supporting hardware and/or software for enabling communications with a wireless communication network. Additionally or alternatively, the communication interface 66 may include the circuitry for interacting with the antenna(s) to cause transmission of signals via the antenna(s) or to handle receipt of signals received via the antenna(s). In some environments, the communication interface 66 may alternatively or also support wired communication. As such, for example, the communication interface 66 may include a communication modem and/or other hardware/software for supporting communication via cable, digital subscriber line (DSL), universal serial bus (USB) or other mechanisms

The apparatus 60 may include a user interface 64 that may, in turn, be in communication with the processor 62 to provide output to the user and, in some embodiments, to receive an indication of a user input. As such, the user interface 64 may include a display and, in some embodiments, may also include a keyboard, a mouse, a joystick, a touch screen, touch areas, soft keys, a microphone, a speaker, or other input/output mechanisms. Alternatively or additionally, the processor 62 may comprise user interface circuitry configured to control at least some functions of one or more user interface elements such as a display and, in some embodiments, a speaker, ringer, microphone and/or the like. The processor 62 and/or user interface circuitry comprising the processor may be configured to control one or more functions of one or more user interface elements through computer program instructions (e.g., software and/or firmware) stored on a memory accessible to the processor 62 (e.g., memory device 68, and/or the like).

As shown in FIG. 2, the apparatus 60 may also include one or more sensors 72 for detecting various parameters associated with the apparatus and/or the user of the apparatus. For example, the apparatus 60 may include sensors 72, such as one or more accelerometers, gyroscopes, temperature sensors, proximity sensors, depth sensors or the like. As described below, the sensors 72 may provide data to the processor 62 from which the context of the user may be determined.

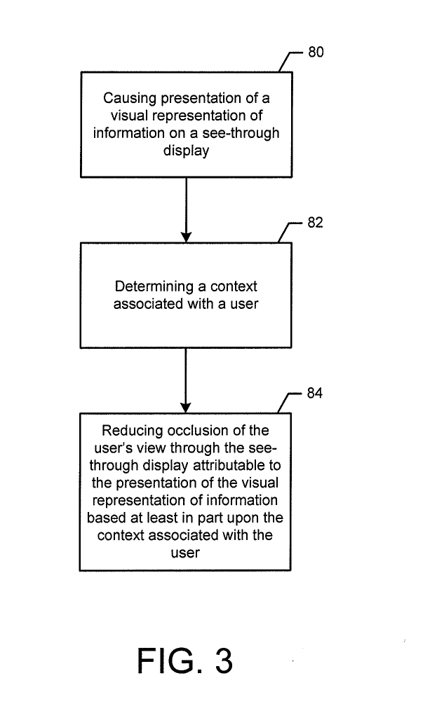

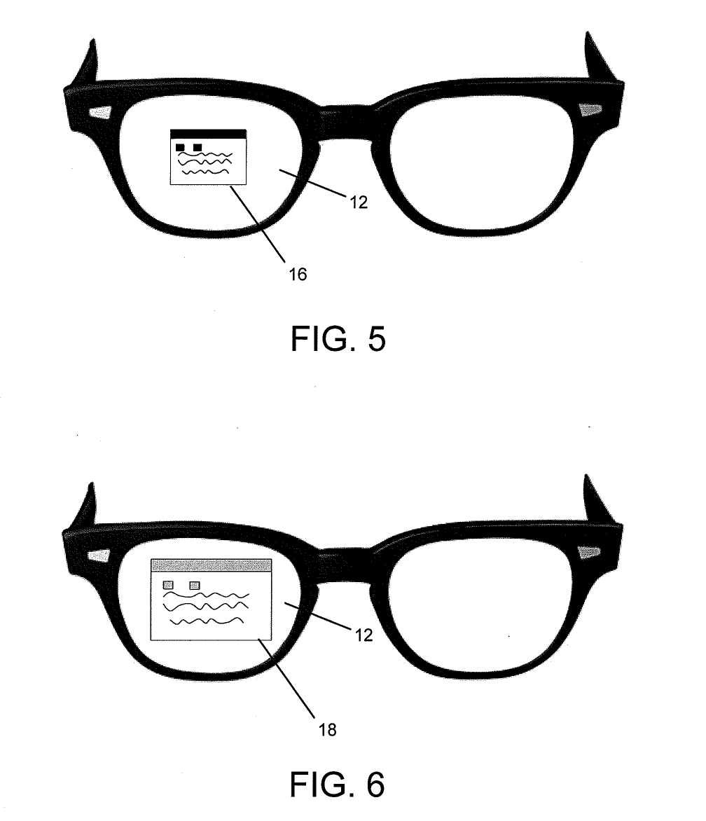

The method, apparatus 60 and computer program product may now be described in conjunction with the operations illustrated in FIG. 3. In this regard, the apparatus 60 may include means, such as the processor 62, the user interface 64, such as a display, or the like, for causing presentation of a visual representation of information of upon the display, as shown in operation 80 of FIG. 5. A visual representation of various types of information may be presented upon the display including, for example, content from various applications, such as textual information, such as textual information relating to one or more objects within the field of view through the see-through display, a map of the surrounding area, information from a contacts application that may relate to nearby individuals, content generated by a gaming application, other types of content or the like.

In FIG. 1, the visual representation 14 of information that is presented upon the see-through display may at least partially occlude the user's view therethrough. In this regard, the user may at least partially view the scene through the see-through display, but portions of the scene may be blocked or otherwise limited as a result of the visual representation 14 of information that is presented upon the see-through display. While the at least partial occlusion of the scene through the see-through display may be appropriate or suitable in a number of situations, the at least partial occlusion of the scene through the see-through display by the visual representation 14 of the information upon the see-through display may be disadvantageous in other situations, such as situations in which the user desires to more fully or more clearly view the scene beyond the see-through display. In these instances in which the user cannot view the scene beyond the see-through display as fully or clearly as is desired, the user may become frustrated or may fail to notice something of import which may, in turn, cause the user to limit their use of the see-through display even though the user may otherwise generally enjoy the visual representation of the additional information upon the see-through display.

As shown in operation 82 of FIG. 3, the apparatus 60 may also include means, such as a processor 62, a sensor 72 or the like, for determining the context associated with the user. In this regard, the context associated with the user may be any of a wide variety of different types of context. In one embodiment, for example, the apparatus 60 may be configured to determine information regarding the surrounding environment in order to define the context associated with the user. For example, the processor 62 and/or the sensor 72, such as a proximity sensor, may identify devices in the proximity of the see-through display. While the apparatus 60, such as the processor 62, may determine the number of devices configured for wireless communications in the proximity of the see-through display, the apparatus, such as the processor, of one embodiment may determine if any of the devices identified to be in the proximity of the see-through display are associated with individuals with which the user of the see-through display has a relationship, such as defined by a contacts application.

However, the context associated with the user may be determined in a variety of other manners in other embodiments of the present invention. As shown in FIG. 4, for example, the context associated with the user may be determined based upon an activity that is performed by the user of the see-through display. In this regard, after causing presentation of a visual representation of information on the see-through display, such as in the same manner as described above in conjunction with operation 80 of FIG. 5, the apparatus 60 may include means, such as a processor 62, a sensor 72 or the like, for determining the context associated with the user by receiving data based upon an activity of the user and then determining the activity performed by the user based upon the data. See operations 90, 92 and 94 of FIG. 4. In this regard, based upon the data collected by one or more sensors 72, the apparatus 60, such as the processor 62, may be configured to determine the activity that is being performed by the user. For example, based upon the acceleration as detected by an accelerometer, the apparatus 60, such as a processor 62, may determine that the user is walking, sitting, sleeping, running or the like. Additionally or alternatively, a sensor 72 may be configured to determine the proximity of a user to other devices, such as devices within a vehicle that may be indicative of the user being within the vehicle and, in an instance in which an accelerometer also detects at least predefined levels of acceleration, that the user is riding or driving in the vehicle. Similarly, the apparatus 60 may also or alternatively include a sensor 72 for detecting other devices of the user, such as a laptop computer, a gaming device, a music player or the like, and may, in some instances, determine the user's context by determining whether the user is interacting with the other device. The apparatus 60 of one embodiment may also include a sensor 72 for detecting objects, such as people, vehicles or other objects, in the vicinity of the user, such as objects that are approaching the user and which may therefore merit increased attention by the user.

Once the context associated with the user has been determined, the occlusion of the user's view through the see-through display that is attributable to the visual representation of the information 14 may be reduced in at least some situations based at least in part on the context associated with the user. In this regard, the apparatus 60 may include means, such as the processor 62 or the like, for determining based upon the context associated with the user whether or not the occlusion otherwise caused by the visual representation of the information on the see-through display should be reduced so as to permit the user to more clearly view the scene through the see-through display. See operations 84 of FIGS. 5 and 96 of FIG. 4.

In regards to instances in which the activity performed by the user is determined as shown, for example in FIG. 4, the apparatus 60, such as the processor 62, may determine whether the user is engaged in an activity that would benefit from increased attention or increased visibility of the scene that could otherwise be viewed through the see-through display. For example, the apparatus 60, such as a processor 62, may include one or more predefined rules that define situations in which the occlusions created by the visual representation of the information presented upon the see-through display should be reduced, such as in instances in which the user is walking or running, but not in instances in which the user is sitting. The processor 62 may implement a wide variety of rules for determining whether or not to reduce the occlusion otherwise created by the visual representation of the information presented upon the see-through display based at least in part upon the context associated with the user. As another example, the processor 62 may cause the occlusion created by the visual representation of the information presented upon the see-through display to be reduced at an instance in which the user is determined to be riding or driving in a vehicle or in which a user is determined to be in the proximity of at least a predefined number of devices and/or a device associated with an associated with an acquaintance of the user. By reducing the occlusion otherwise created by the visual representation of information upon the see-through display, the user may be able to more clearly or completely view the scene through the see-through display and be less distracted by the visual representation of other information presented upon the see-through display.

In an instance in which the context associated with a user is based upon the devices that are proximate to the see-through display, the processor 62 may be configured such that in instances in which only a few devices are identified to be within the proximity of the see-through display, such as fewer than a predefined number of devices, and in which none of the devices that are proximate to the see-through display are identified to be associated with an individual with which the user has a relationship as defined, for example, by a contacts database and/or a historical log of calls, texts or the like, the visual representation of the information that is presented upon the see-through display continues to be presented in a manner that at least partially occludes the view of the user through the see-through display. In these situations, the visual representation of the information may continue to be presented in a manner that may occlude a portion of the user's view since the situation has been determined to be one in which the user need not pay additional attention to the external environment. However, in instances in which a larger number of devices are identified to be in the proximity of the see-through display, such as more than the predefined number of devices, or in instances in which one or more of the devices that are proximate the see-through display are identified to be associated with an individual with whom the user of the see-through display has a relationship, it may be desirable that the visual representation of the information that is presented upon the see-through display does not occlude the users view through the see-through display to as great of an extent such that the user may pay increased attention to the surroundings, which may be crowded or at least include an individual with which the user is acquainted. In these instances, the processor 62 may therefore be configured to reduce the occlusions created by the visual representation of the information upon the see-through display

The apparatus 60 may include means, such as the processor 62, the user interface 64 or the like, may be configured to reduce the occlusion of the user's view through the see-through display attributable to the presentation of the information thereupon in various manners. As shown, for example, in FIG. 5, the apparatus 60 may include means, such as the processor 62, user interface 64 or the like, for reducing the size of the visual representation 16 of information presented upon the see-through display. In contrast to the visual representation 14 of information presented upon the eyeglasses 10 of FIG. 1, the visual representation 16 of information that is presented upon the lens 14 in FIG. 5 is reduced in size, thereby reducing the occlusion to the user's view through the see-through display that is created by the visual representation of the information. In this regard, the same information may be presented upon the see-through display, but the size of the visual representation of the information is reduced so as to facilitate the user's view of the scene through the see-through display.

Additionally or alternatively, the apparatus 60 may include means, such as the processor 62, the user interface 64 or the like, for reducing the opacity of the visual representation 18 of the information presented upon the see-through display. By reducing the opacity of the visual representation 18 of the information presented upon the see-through display, the visual representation of the information is somewhat more transparent such that a user may more readily see through the visual representation of the information presented upon the see-through display so as to see the scene beyond the see-through display. In this regard, FIG. 6 illustrates an example in which the visual representation 18 of the information that is presented upon the see-through display is reduced in opacity relative to that shown in FIG. 1 so as to permit the user to at least partially see through the visual representation 18 of the information.

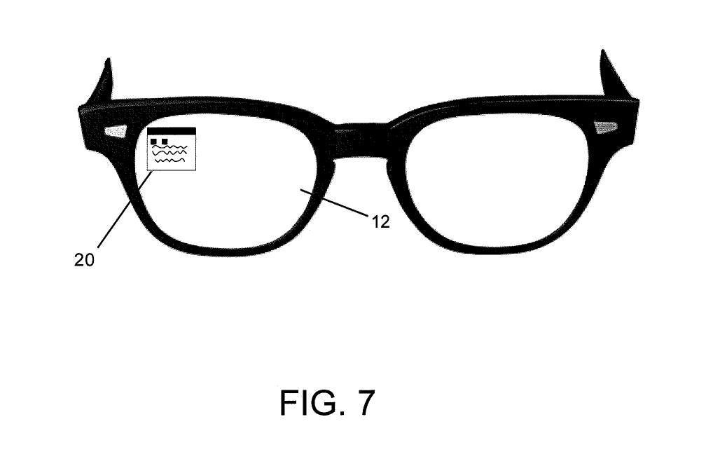

Additionally or alternatively, the apparatus 60 may include means, such as a processor 60, a user interface 64 or the like, for reducing the occlusion of the user's view by causing visual representation of presentation of the information 14 to be moved from an occluding portion of the see-through display in which the visual representation of the information at least partially occludes the user's view of an object through the see-through display to a less-occluding portion of the see-through display in which the visual representation of the information creates less occlusion of the user's view of the object through the see-through display. The occluding portion of the see-through display may be a central portion or any other portion of the see-through display in which the visual representation of the information at least partially occludes the user's view of an object, such as an object that may be considered important, such as a person, a vehicle or other object that is approaching the user. By way of example in which an approaching object is located in a central portion of the see-through display, the visual representation 20 of the information may be moved toward a peripheral portion of the see-through display so as to permit the user to more clearly see through the central portion of the see-through display so as to view the scene beyond the see-through display. In this regard, FIG. 7 illustrates the visual representation 20 of the same information upon a non-central portion of the see-through display (and in a smaller scale) relative to that shown in FIG. 1.

Additionally or alternatively, the apparatus 60 includes means, such as the processor 62, user interface 64 or the like, for reducing the occlusion of the user's view by changing an optical characteristic, such as the color, hue or the like, of the visual representation of the information presented upon the see-through display. In this regard, some colors may create more of a distraction or cognitive tunneling to the user's view through the see-through display than other colors. By way of example, a visual representation of information that is presented in a red color may create a greater distraction to the user's view through the see-through display than a visual representation of the same information presented in a gray color or in a color that is more similar to the coloring of the scene through the see-through display. Thus, while the same visual representation of the information may be presented in the same location upon the see-through display, the change in color may reduce the distraction created by the visual representation of the information and permit the user to more clearly see through the see-through display.

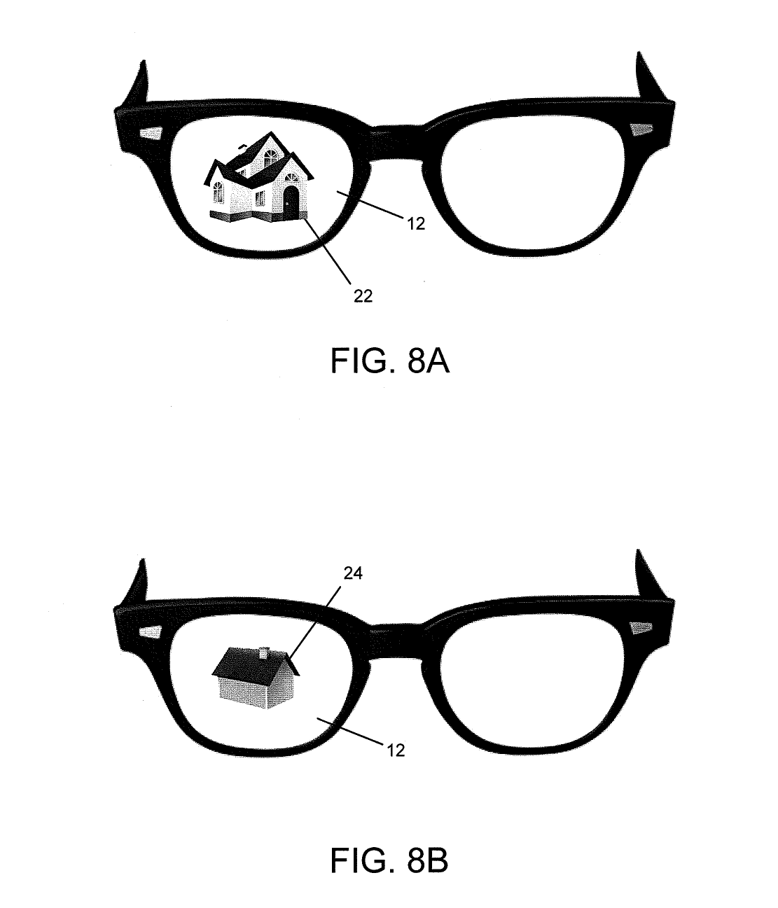

Additionally or alternatively, the apparatus 60 may include means, such as the processor 62, user interface 64 or the like, for reducing the occlusion of the user's view by reducing the informational content or complexity of the visual representation of the information presented upon the see-through display. The informational content or complexity of the visual representation may be changed in various manners so as to reduce the occlusion, such as by simplifying the visual representation of the information, such as from a visually complex and/or textured object 22 as shown in FIG. 8A to a relatively simple object 24 as shown in FIG. 8B, from an object that is in motion to an object that is stationery or by changing the content itself, such as from the presentation of an entire story to the presentation, for example, of simply the headlines of a story. By changing the informational content or complexity of the visual representation of the information that is presented upon the see-through display, such as by simplifying or reducing the information or by presenting the information in a manner that is less likely to draw the user's attention, the user may be able to more clearly see through the see-through display.

While a number of different techniques for reducing the occlusion to the user's view created by the visual representation of information presented upon the see-through display are described above, the apparatus 60 may additionally or alternatively be configured to reduce the occlusion created by the visual representation of the information presented upon the display in another manner, such as by causing the visual representation of the information to be faded such that the intensity of the visual representation of the information presented upon the display is decreased or by terminating the visual representation of at least some of the information previously presented upon the see-through display. Regardless of the manner in which the occlusion of the user's view through the see-through display is reduced, the reduction of the occlusion based upon the context associated with the user may permit the user to more clearly or completely view the scene through the see-through display in instances, for example, in which the user may desire or need to pay increased attention to the surroundings.

In some embodiments, the apparatus 60, such as a processor 62, user interface 64 or the like, may gradually reduce the occlusion created by the visual representation of the information presented upon the see-through display based upon the context associated with the user. In this regard, as the context associated with the user indicates that the user should pay increased attention to their surroundings, the processor 62 may be configured to gradually reduce the occlusion by increasing amounts, such as by reducing the size and/or opacity of the visual representation of the information presented upon the see-through display by increasing amounts or percentages. For example, the processor, may be configured to reduce the occlusion by reducing the size and/or opacity of the visual representation of the information presented upon the display by 25% in an instance in which the user is determined to be walking and to further reduce the occlusion by reducing the size and/or opacity of the visual representation of the information by 50% in an instance in which the user is determine to be running. Thus, the apparatus 60, method and computer program product of one example embodiment may controllably reduce the occlusion based upon the context associated with the user in a manner dependent, at least somewhat, upon the amount of attention that the user is anticipated to pay to these surroundings.

The apparatus 60, such as a processor 62, may also be configured to avoid hysteresis by preventing repeated changes to the visual representation of the information presented upon see-through display, which in and of itself may be distracting. As such, the apparatus 60, such as a processor 62, may include a predefined time limit and may avoid changing the visual representation of the information presented upon the display for at least the predefined time period regardless of the context of the user so as to avoid repeated changes in the manner in which the visual representation of the information is presented upon see-through display.

As described above, FIGS. 3 and 4 illustrate flowcharts of an apparatus 60, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 68 of an apparatus 60 employing an embodiment of the present invention and executed by a processor 62 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified, such as illustrated by a comparison of the operations of FIG. 4 to the operations of FIG. 3. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
causing presentation of a visual representation of information on a see-through display, wherein at least a portion of the visual representation of the information at least partially occludes a user's view through the see-through display;
determining a context associated with the user; and
reducing occlusion of the user's view through the see-through display attributable to the visual representation of the information based at least in part on the context associated with the user.

2. A method according to claim 1 wherein determining the context associated with the user comprises:
receiving data based upon an activity of the user; and
determining the activity performed by the user based upon the data.

3. A method according to claim 1 wherein reducing the occlusion of the user's view comprises reducing a size of the visual representation of the information presented upon the see-through display.

4. A method according to claim 1 wherein reducing the occlusion of the user's view comprises reducing an opacity of the visual representation of the information presented upon the see-through display.

5. A method according to claim 1 wherein reducing the occlusion of the user's view comprises causing the visual representation of the information to be moved from an occluding portion of the see-through display in which the visual representation of the information at least partially occludes the user's view of an object through the see-through display to a less-occluding portion of the see-through display in which the visual representation of the information creates less occlusion of the user's view of the object through the see-through display.

6. A method according to claim 1 wherein reducing the occlusion of the user's view comprises changing an optical characteristic of the visual representation of the information presented upon the see-through display.

7. A method according to claim 1 wherein reducing the occlusion of the user's view comprises reducing an informational content or complexity of the visual representation of the information presented upon the see-through display.

8. A method according to claim 1 wherein reducing the occlusion of the user's view comprises causing the visual representation of the information to be modified differently in a central portion of the see-through display than in a non-central portion of the see-through display.

9. An apparatus comprising at least one processor and at least one memory storing computer program code, wherein the at least one memory and stored computer program code are configured, with the at least one processor, to cause the apparatus to at least:
cause presentation of a visual representation of information on a see-through display, wherein at least a portion of the visual representation of the information at least partially occludes a user's view through the see-through display;
determine a context associated with the user; and
reduce occlusion of the user's view through the see-through display attributable to the visual representation of the information based at least in part on the context associated with the user.

10. An apparatus according to claim 9 wherein the at least one memory and stored computer program code are configured, with the at least one processor, to cause the apparatus to determine the context associated with the user by:
receiving data based upon an activity of the user; and
determining the activity performed by the user based upon the data.

11. An apparatus according to claim 9 wherein the at least one memory and stored computer program code are configured, with the at least one processor, to cause the apparatus to reduce the occlusion of the user's view by reducing a size of the visual representation of the information presented upon the see-through display.

12. An apparatus according to claim 9 wherein the at least one memory and stored computer program code are configured, with the at least one processor, to cause the apparatus to reduce the occlusion of the user's view by reducing an opacity of the visual representation of the information presented upon the see-through display.

13. An apparatus according to claim 9 wherein the at least one memory and stored computer program code are configured, with the at least one processor, to cause the apparatus to reduce the occlusion of the user's view by causing the visual representation of the information to be moved from an occluding portion of the see-through display in which the visual representation of the information at least partially occludes the user's view of an object through the see-through display to a less-occluding portion of the see-through display in which the visual representation of the information creates less occlusion of the user's view of the object through the see-through display.

14. An apparatus according to claim 9 wherein the at least one memory and stored computer program code are configured, with the at least one processor, to cause the apparatus to reduce the occlusion of the user's view by changing an optical characteristic of the visual representation of the information presented upon the see-through display.

15. An apparatus according to claim 9 wherein the at least one memory and stored computer program code are configured, with the at least one processor, to cause the apparatus to reduce the occlusion of the user's view by reducing an informational content or complexity of the visual representation of the information presented upon the see-through display.

16. An apparatus according to claim 9 wherein the at least one memory and stored computer program code are configured, with the at least one processor, to cause the apparatus to reduce the occlusion of the user's view by causing the visual representation of the information to be modified differently in a central portion of the see-through display than in a non-central portion of the see-through display.

17. A computer program product comprising at least one non-transitory computer-readable storage medium having computer-readable program instructions stored therein, the computer-readable program instructions comprising:
program instructions configured to cause presentation of a visual representation of information on a see-through display, wherein at least a portion of the information at least partially occludes a user's view through the see-through display;
program instructions configured to determine a context associated with the user; and
program instructions configured to reduce occlusion of the user's view through the see-through display attributable to the visual representation of the information based at least in part on the context associated with the user.

18. A computer program product according to claim 17 wherein the program instructions configured to determine the context associated with the user comprise:
program instructions configured to receive data based upon an activity of the user; and
program instructions configured to determine the activity performed by the user based upon the data.

19. A computer program product according to claim 17 wherein the program instructions configured to reduce the occlusion of the user's view comprise program instructions configured to reduce an opacity of the visual representation of the information presented upon the see-through display.

20. A computer program product according to claim 17 wherein the program instructions configured to reduce the occlusion of the user's view comprise program instructions configured to cause the visual representation of the information to be moved from an occluding portion of the see-through display in which the visual representation of the information at least partially occludes the user's view of an object through the see-through display to a less-occluding portion of the see-through display in which the visual representation of the information creates less occlusion of the user's view of the object through the see-through display.
